(19) United States
(12) Patent Application Publication
(10) Pub. No.: US 2010/0200648 A1
(43) Pub. Date: Aug. 12, 2010

(54) METHOD AND SYSTEM FOR INFORMING CONSUMERS OF PRODUCT ORIGIN AND HISTORY

(75) Inventors: Patrick James Newton, Middlesex (GB); Nigel John Dore, Berkshire (GB)

Correspondence Address: PEPPER HAMILTON LLP, ONE MELLON CENTER, 50TH FLOOR, 500 GRANT STREET, PITTSBURGH, PA, 15219, US

(73) Assignee: Helveta Limited, Oxfordshire (GB)

(21) Appl. No.: 12/367,785

(22) Filed: Feb. 9, 2009

(51) Int. Cl. G06F 19/00

(52) U.S. Cl. 235/375

(57) ABSTRACT

A system for providing consumer access to product origin information. The system includes a server configured to assign a tracking identifier (TID) relating to a specific product and a product information portal (PIP) operably connected to the server, the PIP containing a product information record (PIR) related to an individual TID and providing an interface to a consumer access area such that a consumer accessing the PIP can view a PIR for a selected product.

### BACKGROUND

The present invention relates to tracking product origin and history information. More specifically, the present invention relates to providing access to product origin and history information to consumers via a communications network.

Recent history has seen a significant increase in the industrialization of previously un-industrialized or even un-civilized areas. Along with this industrialization, global commerce has increased rapidly as well. Faster, cheaper methods of transporting, advertising, and selling goods have developed, providing for a truly global marketplace.

Along with the development of the global marketplace, there has been a significant increase in the importance consumers place on product origin and product production information. Historically, there has been little or no concern on the part of consumers as to product information. This information was generally not provided to the consumers, and if it was, it was merely based on a paper trail that could have been forged or changed at many points along the production path of a product. However, with an increased global awareness, and a growing movement for the preservation of natural resources, consumer attitude is shifting. For example, many consumers are now concerned as to whether the materials used in manufacturing a product, or the processes used to produce a product, have caused any environmental damage. For example, a consumer may be concerned that the wood used to produce a certain object (e.g., a piece of furniture) may have come from a protected forest. Similarly, some producers of goods are becoming concerned with product origin and product production information. For example, an organic farmer may spend a significant amount of money compared to a conventional farmer. The organic farmer labels his goods as organic, and charges a slightly higher price to offset the higher expenses. However, without a way of tracking production of the goods, a consumer may not trust the items to be organic, or, the conventional farmer may label his goods as organic and charge a lower price. Without product origin and production information, there is no way for a consumer to confirm what goods are as they are advertised, i.e., is produce truly organic or is the wood used to manufacture an item from a “green” forest, or a forest that requires replenishment of trees as they are chopped down.

Developing simultaneously with the consumer desire for product information is consumer access to information via a communications network such as the Internet. The Internet provides a platform for consumers to access information in nearly all aspect of their lives. Banking, shopping, entertainment (e.g., videos, music, books) and many other types of information is now available to a consumer via the Internet. Similarly, producers of goods have been increasing using the Internet to market their goods. Thus, the Internet has provided both consumers and producers a truly global platform to buy, sell and market goods.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “product” is a reference to one or more consumer products and equivalents thereof known to those skilled in the art, and so forth. Unless defined otherwise, all technical and scientific terms used herein have the same meanings as commonly understood by one of ordinary skill in the art. As used herein, the term “comprising” means “including, but not limited to.”

In one general respect, the embodiments disclose a system for providing consumer access to product origin information. The system includes a server configured to assign a tracking identifier (TID) relating to a specific product and a product information portal (PIP) operably connected to the server, the PIP containing a product information record (PIR) related to an individual TID and providing an interface to a consumer access area such that a consumer accessing the PIP can view a PIR for a selected product.

In another general respect, the embodiments disclose a method for providing consumer access to product origin information. The method includes the steps of assigning a tracking identifier (TID) to an individual product, linking a product information record to a TID, and providing a consumer access area via a product information portal (PIP) where a consumer can access a product information record (PIR), wherein the PIR includes additional information relating to the history of the product.

### BRIEF DESCRIPTION OF THE DRAWINGS

Aspects, features, benefits and advantages of the present invention will be apparent with regard to the following description and accompanying drawings, of which:

FIG. 1 illustrates an exemplary network for use by a producer for defining product information;

FIG. 2 illustrates an exemplary network for use by a consumer in obtaining product information;

FIG. 3 illustrates a flowchart of an exemplary process for tracking production information for a product.

### DETAILED DESCRIPTION

The method and system described herein focus on providing an interface to a consumer for verifying the origins of a product. In one embodiment, an identifier (referred to hereinafter as a “Tracking ID” or “TID”) may be associated with a product and used to identify the product through manufacture/production of the product, and also may be used by a consumer to locate product origin and production information for the product at a later time (e.g., when the consumer is shopping for a particular good). The TID may be physically printed on a product, or otherwise associated with a product by appending the TID to advertisements relating to a product, or to other documents relating to the product. A TID may be globally unique or unique within a particular industry or geographic region. Additionally, a single TID may be assigned to a single product, or an entire batch of products (e.g., all products manufactured from a single tree).

A consumer researching or purchasing a product may take note of the assigned TID and accesses a Product Information Portal (PIP) via their web browser over the Internet. The PIP may either be a global portal or a specific incarnation of the portal for a unique domain. The PIP has a search box into which the consumer can enter the TID. On submitting a valid TID, the PIP will respond with information about the product either directly within the response page or via links to other sources such as a link directly to the manufacturer of the product. This information may include some or all of the following plus potentially other information relevant to the product:
The geographical origin of the product at an appropriate resolution (e.g. map coordinates, town, region, country, trading block);
Date of production;
Regulatory approvals associated with production of the product;
Certifications associated with the production of the product;
Images or videos of the product or similar products before and/or in production;
Images, videos, audio and/or text information related to individuals involved in the production of the product;
Images, videos, audio and/or text information related to the production process;
Images, videos, audio and/or text information related to the region or country of origin;
Images, videos, audio and/or text information related to indigenous communities living in the region of production;
A full or partial record of the product chain of custody from origin to the point of sale;
Care information for the product; and
Targeted advertising.
   It should be noted this list is provided only for exemplary purposes, and the actual information contained in the PIP may vary depending on the product. Similarly, the PIP may offer interactive facilities to a consumer such as:
Messaging to/from those involved in production or sale of the product;
Access to other consumer reviews/ratings of the product (rolled up to product type from individual product instance if required);
An ability to submit their own reviews or ratings of products;
Social networking opportunities with consumers who are interested in similar products;
Other opportunities for interaction such as interactive forums;
Resale opportunities for the product;
Warranty activities related to the product; and
Derived data such as most accessed/top rated products.
   Again, as before, it should be noted this list is provided for exemplary purposes only and may vary from product to product, and manufacturer to manufacturer. To access some or all of these facilities, a consumer may register their personal information with the PIP and receive sign-in credential information. Subject to suitable data privacy provisions, the PIP may then use data from the user activities on the PIP (e.g., product TIDs accessed and viewed) to offer a further targeted user experience (e.g., personalize advertising based upon user preferences).

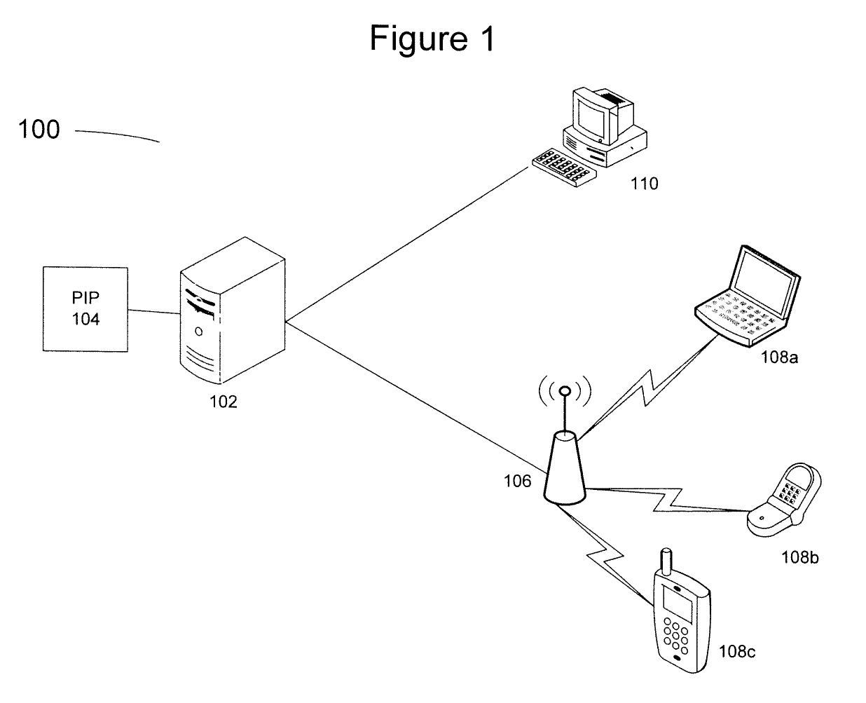

FIG. 1 illustrates an exemplary network 100 for use by a producer to define product origin and production information. Network 100 includes a centralized server 102 for hosting the PIP 104 while permitting access from various vendor, supplier or producer computing devices 108a-c and 110 (for convenience, “supplier” will relate to all aspects of product manufacture and production, including vendors, suppliers, manufacturers, transporters, advertisers, etc.). It should be noted that while a single server is shown in this example, multiple servers may be used to host various databases and information related to authorized suppliers, TIDs and related data. Each supplier device may designate an assigned TID to a product or batch of products (for convenience, a product will relate to a single product and a batch of products).

Once a TID is assigned, the TID may be linked to a product information record (PIR). Once a TID is linked to a PIR, the TID may be used to update information relating to the product, and the PIR may be accessed by a consumer to review the related information. Linking a TID and PIR may be performed when the TID is issued, or at a later time via a manual, web or electronic transaction. Typically the PIR information may be provided by other electronic systems or extracted from paper records. Optionally, the PIP may use the source of PIR information to provide a consumer with additional information relating to a level of trust that may be applied to the information based upon individual supplier trust levels.

Once a TID is assigned for a product and the PIR is created, various supplier devices may access the PIP 104 and update the information relating to the TID contained in the PIR. Over a communications network, such as the Internet, server 102 connects to wireless access point 106 allowing various wireless devices to access server 102, e.g., laptop 108a, cell phone 108b and PDA 108c. A user of each of these devices may access server 102 and update PIP 104 at various stages of production.

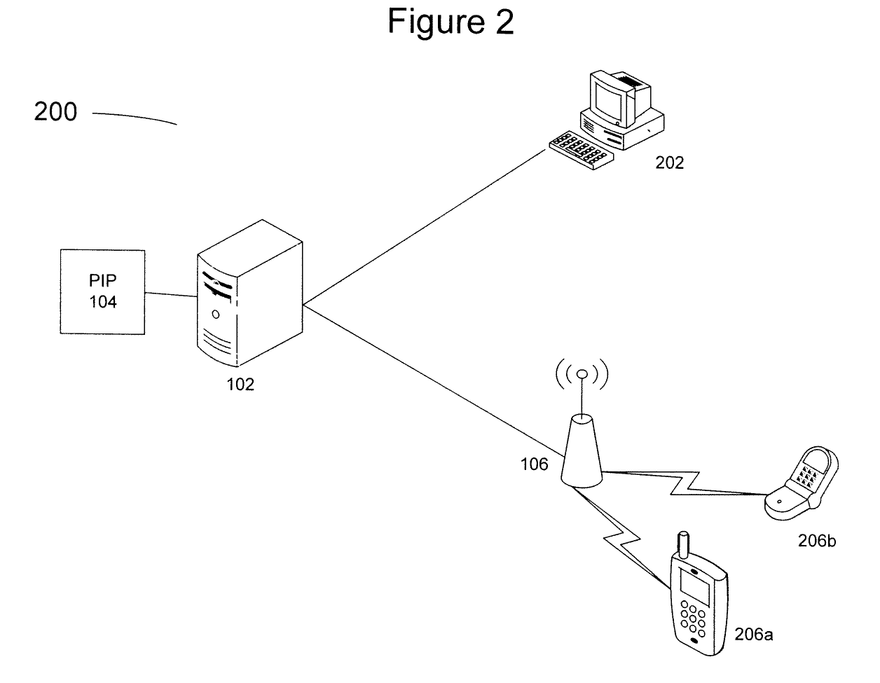

Along the production process, suppliers may access server 102 and PIP 104 to update the information contained in the PIR. This ensures once a product is available for consumer review and/or purchase, the PIP 104 accurately reflects all product origin and production information related to the product. FIG. 2 illustrates an exemplary network 200 for use by a consumer to access server 102 and PIP 104. A consumer may use a personal computer 202 to access server 102 via a communications network such as the Internet. Similarly, a consumer may use a wireless device such as PDA 206a or cell phone 206b to connect to wireless access point 204, and ultimately access PIP 104. This provides a consumer the opportunity to research a particular TID that the consumer may discover while out shopping or at a product supplier, such as a furniture showroom. For example, a consumer may be at a furniture showroom and find a TID on a product along with the Internet address of a portal where the consumer may access the PIP. The user directs their computing device (e.g., PDA 206a) toward the portal and connects to server 102. The consumer enters the TID and obtains the information contained in the PIP 104. If the user is content with the information contained therein, they may choose to buy the product, not to buy the product, or perform additional research

It should be noted that the TID may be used to obtain information at any point during the lifetime of a product. For example, a consumer may purchase a product having a TID and research the origins of the product at some time after purchase. Additionally, a consumer may opt to resell a product having a TID, and a new purchaser may use the TID to research the origin information from the product before or after purchasing the product from the original owner. The above discussion regarding performing a TID search before purchase is shown by way of example only.

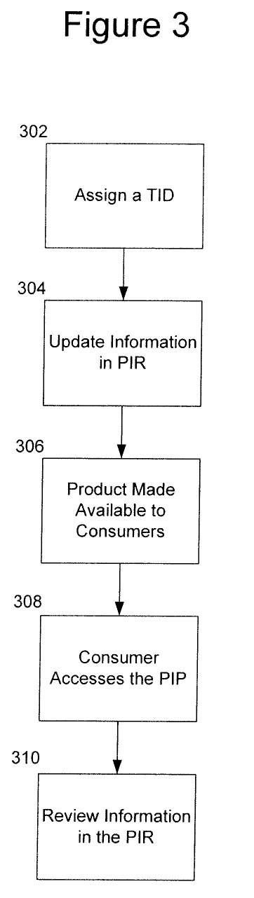

FIG. 3 illustrates an exemplary flowchart for using the system and processes described herein. The process begins when a TID is assigned 302 and a related PIR is created. As discussed above, a single or multiple TIDs may be assigned at a time. For convenience, this example assumes a single TID is assigned 302. After the TID is assigned 302, a supplier accesses the PIP and updates 304 the PIR for an associated TID to reflect product origin information relating to an individual product. After the information contained in the PIR is updated 304, the product is finalized and made available 306 to consumers for review and/or purchase. It should be noted that updating the information in the PIR is an ongoing process and may not end once the product is put up for sale. The PIR may be updated 304 to include information relating to the sale and transport of the product until the product ultimately reaches the consumer. After the product is made available 306, a user may access 308 the PIP, and review 310 the product information contained in the PIR. Upon review 310, the consumer may ultimately decide to purchase the product, or to perform additional research on related products or services.

It will be appreciated that the above described systems and methods are provided for exemplary purposes only, and may be expanded to include or cover additional embodiments. For example, the area of production may include drug manufacture, agricultural suppliers, furniture or other goods manufactured from processed lumber, and any other area of manufacture that may lend itself to product origin and production information tracking. Similarly, the hardware components of the systems described above may vary from application to application. For example, the communication networks used may vary between public and private networks, the databases used may contain additional information including information pertaining to registered consumers, and additional areas of information (e.g., a supplier's web site) may be linked to in the PIR information.

It will also be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for providing consumer access to product origin information, the system comprising:
a server configured to assign a tracking identifier (TID) relating to a specific product;
a product information portal (PIP) operably connected to the server, the PIP containing a product information record (PIR) related to an individual TID and providing an interface to a consumer access area such that a consumer accessing the PIP can view a PIR for a selected product.

2. The system of claim 1, wherein the PIP further comprises base information about the specific product stored in the PIR.

3. The system of claim 2, wherein the base information comprises at least one of region of origin of the specific product, production methods for manufacturing the specific product, date of production, supply chain, and additional historic information.

4. The system of claim 3, wherein the consumer access area is configured to include advertising, reviews, ratings, messaging and social networking features related to a specific product TID.

5. The system of claim 1, wherein the server further comprises at least one database configured to store information relating to suppliers, assigned TIDs, and product information.

6. The system of claim 1, wherein the PIP and the server are connected over a private network connection.

7. The system of claim 1, wherein the PIP and the server are connected over a public network connection.

8. The system of claim 1, wherein a consumer accesses the PIP via an Internet connection.

9. A method for providing consumer access to product origin information, the method comprising:
assigning a tracking identifier (TID) to an individual product;
linking a product information record to a TID; and
providing a consumer access area via a product information portal (PIP) where a consumer can access a product information record (PIR), wherein the PIR includes additional information relating to the history of the product.

10. The method of claim 9, wherein the PIP further comprises base information about the specific product stored in the PIR.

11. The method of claim 10, wherein the base information comprises at least one of region of origin of the specific product, production methods for manufacturing the specific product, date of production, supply chain, and additional historic information.

12. The method of claim 9, wherein the consumer access area is configured to include advertising, reviews, ratings, messaging and social networking features related to a specific product TID.
